(19) United States
(12) Patent Application Publication
(10) Pub. No.: US 2025/0037174 A1
(43) Pub. Date: Jan. 30, 2025

(54) ELECTRONIC PRODUCT AND SERVICE FULFILLMENT

(71) Applicant: PETER REX, BELLEVUE, WA (US)

(72) Inventor: PETER REX, BELLEVUE, WA (US)

(21) Appl. No.: 18/788,829

(22) Filed: Jul. 30, 2024

Related U.S. Application Data
(63) Continuation of application No. 17/243,134, filed on Apr. 28, 2021, now abandoned.
(60) Provisional application No. 62/704,224, filed on Apr. 28, 2020.

(51) Int. Cl. G06Q 30/02; G06Q 30/01; H04W 4/14

(52) U.S. Cl. CPC G06Q 30/0281; G06Q 30/01; H04W 4/14

(57) ABSTRACT

At least one computer-readable medium on which are stored instructions that, when executed by one or more processing devices, enable the one or more processing devices to perform a method. The method includes the steps of providing a contact number accessible to a short service message service (SMS), receiving from a user via the contact number an SMS request for a business transaction, sorting the request according to a characteristic of the request, based on the characteristic, choosing a transaction fulfillment entity to which to route the request, receiving from the transaction fulfillment entity a response to the request, and transmitting the response to the user via SMS.

### PRIORITY CLAIM

This application is a Continuation of U.S. patent application Ser. No. 17/243,134 filed Apr. 28, 2021, which application claims priority from U.S. Provisional Application Ser. No. 62/704,224 filed Apr. 28, 2020, the entirety of which is hereby incorporated by reference as if fully set forth herein.

### COPYRIGHT NOTICE

This disclosure is protected under United States and/or International Copyright Laws. © 2024 PETER REX. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

The ordering of goods and services using electronic devices, such as smartphones, via applications (“apps”) installed thereon has become commonplace. However, doing so typically and inconveniently requires that a user download the application, log into the application, set up an account and learn how to use the application.

### BRIEF DESCRIPTION OF THE DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 illustrates screenshots showing communication between a customer and request fulfillment agent according to an embodiment of the invention; and

FIG. 4 is a functional block diagram of an exemplary operating environment in which an embodiment of the invention can be implemented.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

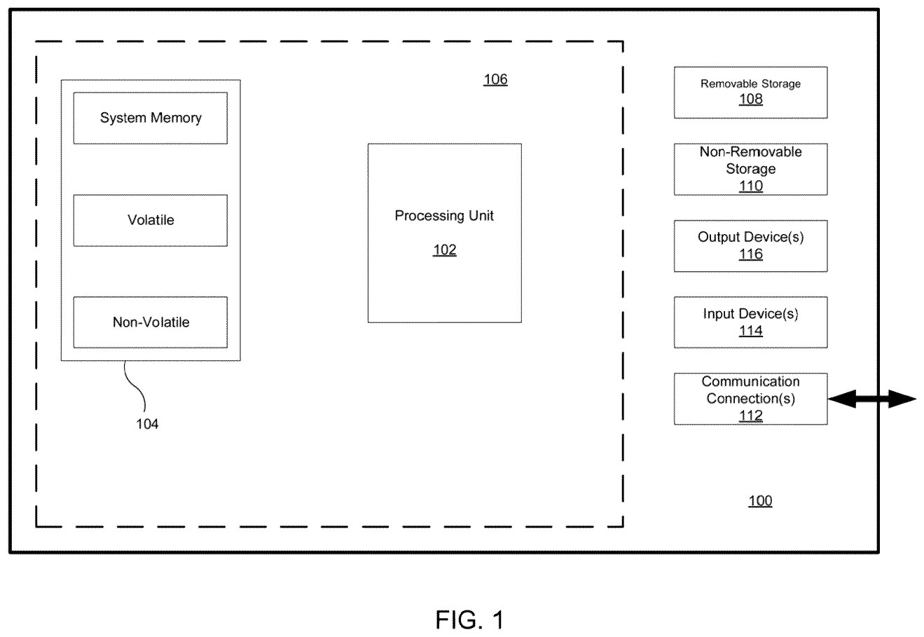

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

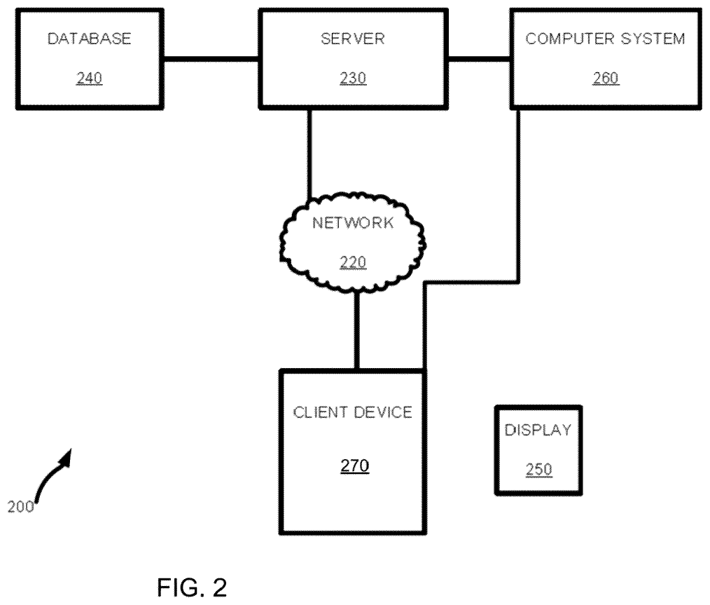

Referring now to FIG. 2, an embodiment of the present invention may take the form, and/or may be implemented using one or more elements, of an exemplary computer network system 200. The system 200 includes an electronic client device 270, such as a personal computer or workstation, tablet or smartphone, that is linked via a communication medium, such as a network 220 (e.g., the Internet), to one or more electronic devices or systems, such as a server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network-and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. The data stored in database 240 may include, for example, information identifying customers, goods/services previously requested by such customers and providers of those goods/services. Additionally, the server 230 may be coupled to the computer system 260 in a manner allowing the server to delegate certain processing functions to, or otherwise leverage the processing capabilities of, the computer system. In an embodiment, most or all of the functionality described herein may be implemented in a desktop or smartphone application that may include one or more executable modules. In an embodiment, the client device 270 may bypass network 220 and communicate directly with computer system 260.

An embodiment of the invention provides a method of delivering services or goods to a requesting client in a more efficient way. In an embodiment, services or goods are requested from an app-based software without downloading or opening the app by leveraging a combination of technologies including SMS (text messages), mobile phones, a web-app or downloaded native app, a phone number, a text message routing technology, a sorting application, and a purpose-built app console. In an embodiment, a customer requests, manages, and acknowledges completion of service/goods transactions via SMS interaction with the software. The customer is not required to provide a code, PIN number or any other authorizing/authenticating/identifying information other than perhaps the customer's phone number.

One or more embodiments may employ the following technologies: SMS, Text message routing technology, Text message sorting technology, Smartphone, Purpose built app console, and Native or web-app.

In a system according to an embodiment, a customer desiring a good/service can express intent to order the good/service by sending simple SMS messages in a native text messaging user interface on client device 270 such as, for example, a mobile smartphone. The customer can begin the process by sending an SMS text message to a specific phone number monitored by the server 230 and designated for order-relevant communications. Next, the customer's phone number can be tagged by the server 230 to indicate its correlation with the specific order that the customer requested. If the customer has previously used the service provided by an embodiment, his basic information will be known by the server 230 and will better facilitate order fulfillment. If the customer is requesting a good/service that the customer has never previously requested or has otherwise never used the service before, the server 230 can use SMS communication to ask the customer for needed information, such as, for example, the specific good/service desired, the party to whom the customer wishes to supply the desired good/service and minimum or maximum charges that the customer is willing to incur to acquire the good/service. The server 230 can assume that any text message coming from the customer's number is from the same customer and with regard to the most recently placed order. During the period of time after order placement and before the order is completed, the customer can also communicate, manage, and take key actions purely over SMS if they choose, without ever logging into an application or a website.

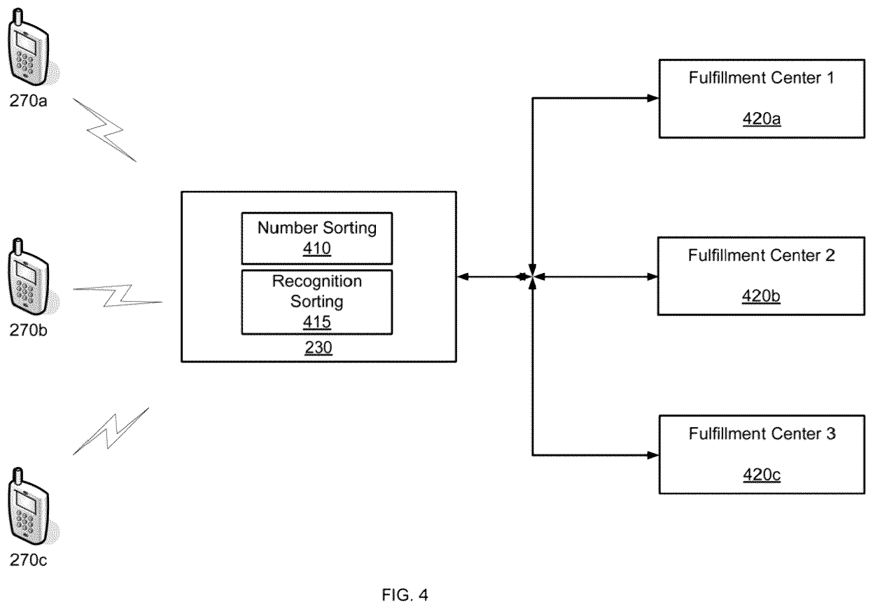

Referring to FIG. 4, and in a first embodiment of the invention, a customer initiates an order for a good or service by sending a text message from a client device 270 to server 230 using one of a plurality of designated SMS numbers uniquely associated with a fulfillment entity/center 420 that provides the desired good/service. As such, different numbers would be available for different offerings (e.g., a customer texts 313-DONE for home-maintenance requests or 414-DONE for dog-walking requests). In this embodiment, a number sorting application 410 executed by the server 230 monitors each SMS message incoming from client devices 270 and, based on the particular number to which the message is directed, routes the order associated with the message through wired or wireless means to the appropriate fulfillment center 420 for order processing.

Referring again to FIG. 4, and in an alternative embodiment of the invention, a customer initiates an order for a good or service by sending a text message from a client device 270 to server 230 using a designated SMS number associated with server 230. In this embodiment, a recognition sorting application 415 executed by the server 230 monitors each SMS message incoming from client devices 270 and, based on one or more characteristics associated with the message, routes the order associated with the message to the appropriate fulfillment center 420 for order processing. In this embodiment, the recognition sorting application 415 may route the request for order processing through wired or wireless means to a particular fulfillment center 420 based on one or more characteristics that may include one or more keywords, images and/or patterns in the text message that indicate the type of good/service requested and that are recognized by artificial intelligence associated with the recognition sorting application. The routing and sorting functions may be performed on respective different servers or on the same server such as server 230. In an embodiment, the routing and sorting functions are cloud-based services that also integrate with the service request and fulfillment system.

As such, a processing device such as server 230 according to one or more embodiments executes routing, provides customer recognition, and provides ordering business logic. It also provides fulfillment agents with specific features to effectively take orders, fulfill, perform quality assessment, and complete customer orders with accuracy at high volumes. One or more sorting applications 410, 415, which may consist of or otherwise include artificial intelligence executed by or otherwise associated with server 230 and/or computer system 260, responds to the customer as needed in order to fulfill the customer's need and facilitate a transaction. Such a response will in some instances be automatically generated. When this is the case, a system according to an embodiment can detect keywords to trigger specific automatic responses. If no keywords are detected, responses can be generated manually by fulfillment personnel. Such artificial intelligence may include keyword recognition, image recognition, non-keyword pattern recognition, and other capabilities.

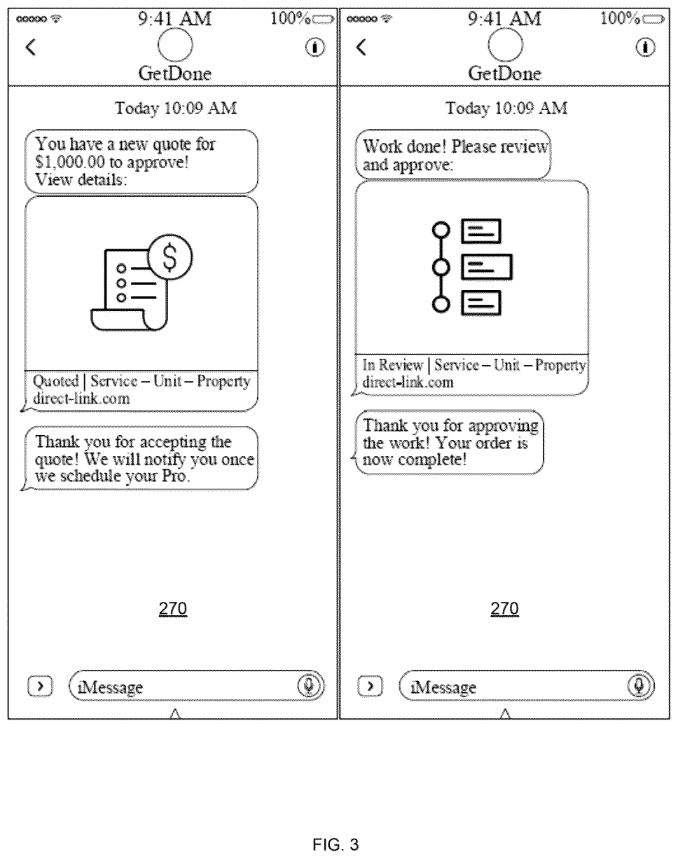

As best illustrated in FIG. 3, the customer can communicate via native SMS anything necessary for the end-to-end completion of the transaction they need including confirming the details of an order, placing an order, signing a service contract, marking a project complete, communicating special instructions, communicating changes in their intent to order, canceling an order, and authorizing payment. A customer can also be notified of any progress made toward the completion of a transaction and also of any action required of the customer for the completion of the transaction.

In an embodiment, and by way of further example, a transactional process may proceed as described herein below.

Sending only an SMS message (video, photo, voice memo, text) to initiate an order for good/service.

System generated SMS messages for key updates related to service orders or account information.

Customer replies over SMS to take key actions.

Customer replies “approve” over SMS to approve a quote.

Customer replies “help” over SMS to initiate customer support for a job.

Customer replies “cancel order” to initiate support.

Service provider sends “started” to indicate start of job.

Service provider sends “complete” to indicate completion of the job.

While the preferred embodiment of the invention has been illustrated and described, as noted above, many changes can be made without departing from the spirit and scope of the invention. For example, server 230 may be configured to simultaneously execute both sorting applications 410, 415. Accordingly, the scope of the invention is not limited by the disclosure of the preferred embodiment. Instead, the invention should be determined entirely by reference to the claims that follow.

What is claimed is:

1. At least one computer-readable medium on which are stored instructions that, when executed by one or more processing devices, enable the one or more processing devices to perform a method, the method comprising the steps of:
providing a contact number accessible to a short service message service (SMS);
receiving from a user via the contact number an SMS request for a business transaction;
sorting the request according to a characteristic of the request;
based on the characteristic, choosing a transaction fulfillment entity to which to route the request;
receiving from the transaction fulfillment entity a response to the request; and
transmitting the response to the user via SMS.

2. The medium of claim 1, wherein the characteristic comprises a keyword indicating the type of transaction requested.

3. The medium of claim 1, wherein the characteristic comprises an image indicating the type of transaction requested.

4. The medium of claim 1, wherein the user is not required to provide a code with the request.

5. The medium of claim 1, wherein the user is not required to provide a personal identification number with the request.

6. At least one computer-readable medium on which are stored instructions that, when executed by one or more processing devices, enable the one or more processing devices to perform a method, the method comprising the steps of:
providing a first contact number of a plurality of contact numbers accessible to a short service message service (SMS);
receiving from a user via the first contact number an SMS request for a business transaction;
sorting the request according to the first contact number;
based on the first contact number, choosing a first transaction fulfillment entity of a plurality of transaction fulfillment entities to which to route the request;
receiving from the first transaction fulfillment entity a response to the request; and
transmitting the response to the user via SMS.

7. The medium of claim 6, wherein the user is not required to provide a code with the request.

8. The medium of claim 6, wherein the user is not required to provide a personal identification number with the request.
